(19) United States
(12) Patent Application Publication
(10) Pub. No.: US 2026/0084647 A1
(43) Pub. Date: Mar. 26, 2026

(54) SEAT BELT RETRACTOR

(71) Applicant: ASHIMORI INDUSTRY CO., LTD., Osaka (JP)

(72) Inventors: Shigehiko KUBO, Settsu-shi (JP); Takayoshi IJIRI, Settsu-shi (JP)

(21) Appl. No.: 19/337,595

(22) Filed: Sep. 23, 2025

(30) Foreign Application Priority Data
Sep. 25, 2024 (JP) 2024-165912

(51) Int. Cl. B60R 22/46; B60R 22/36

(52) U.S. Cl. CPC B60R 22/4628; B60R 22/36

(57) ABSTRACT

A seat belt retractor includes a winding drum, a locking base, and a pretensioner. The pretensioner includes a drive wheel, a pressure container, and a moving member. The pressure container is provided such that an opening direction of the terminal end portion is tilted toward the winding drum or opposite to the winding drum, with respect to a plane orthogonal to an axial direction of the winding drum. When the pretensioner is activated, the moving member moves the locking base, the drive wheel, and the winding drum to the opening direction side of the terminal end portion of the pressure container in the axial direction of the winding drum, and brings one of the locking base, the drive wheel, and the winding drum into contact with a restricting member.

### CROSS REFERENCE TO RELATED APPLICATION

This application claims priority to and the benefit of Japanese Patent Application No. 2024-165912 filed on Sep. 25, 2024, the entire disclosure of which is incorporated herein by reference.

### BACKGROUND OF THE INVENTION

### Field of the Invention

The present disclosure relates to a seat belt retractor including a pretensioner for eliminating slack of a webbing in an emergency such as vehicle collision.

Description of the Related Art

In the related art, there is a seat belt retractor including a pretensioner for eliminating slack of a webbing in an emergency such as vehicle collision. For example, JP6752631B2 discloses a seat belt retractor 100 illustrated in FIG. 20.

Specifically, in the seat belt retractor 100, a winding drum 120 (referred to as a “spool” in JP6752631B2) configured to wind up a webbing 200 is rotatably housed between a pair of side walls 111 and 112 (referred to as “leg plates” in JP6752631B2) of a housing 110 (referred to as a “frame”in JP6752631B2), and a pretensioner 130 is provided to one side wall 111.

The pretensioner 130 includes a drive wheel 131 (referred to as a “connection member” in JP6752631B2) provided on one end side of the winding drum 120, a moving member 132 (referred to as a “rack” in JP6752631B2) configured to rotate the drive wheel 131 in the winding direction of the webbing 200 in an emergency of a vehicle, a pipe (cylindrical pressure container) (not illustrated) that houses the moving member 132 in a normal state, and a cover member 133 that houses the drive wheel 131. The moving member 132 moves inside the pipe and inside the cover member 133 by the pressure of gas supplied from a gas generator in an emergency of a vehicle, to be engaged with engaging teeth of the drive wheel 131.

In the retractor 100, a locking base 140 (referred to as a “lock base” in JP6752631B2) is attached to the winding drum 120 via the drive wheel 131. In a normal state, the locking base 140 rotates together with the winding drum 120, and in an emergency of the vehicle, a pawl 150 held by the locking base 140 is engaged with internal teeth formed on the cover member 133, whereby rotation of the locking base 140 in the pull-out direction of the webbing 200 is prevented.

Further, in the retractor 100, movement of the locking base 140 and the drive wheel 131 toward one side (right side in FIG. 20) in the axial direction of the winding drum 120 is restricted by a peripheral edge of the drive wheel 131 coming into contact with the side wall 111. Movement of the locking base 140 and the drive wheel 131 toward the other side (left side in FIG. 20) in the axial direction of the winding drum 120 is restricted by a stepped portion of a shaft portion of the locking base 140 coming into contact with a cover member 160 that houses a lock mechanism.

### SUMMARY OF THE INVENTION

In JP6752631B2, the movement direction of the moving member 132 is not clearly described, but from FIG. 20, it is considered that the movement direction is a direction perpendicular to the axial direction of the winding drum 120. However, in this case, when the pretensioner 130 is activated, which side in the axial direction of the winding drum 120 the locking base 140 and the drive wheel 131 will move is not defined. That is, a sliding resistance due to contact for restricting movement differs depending on the movement direction, and thus a retraction force for the webbing by the pretensioner might not be stabilized.

An aspect of non-limiting embodiments of the present disclosure relates to providing a seat belt retractor that can stabilize a retraction force for a webbing by a pretensioner.

According to an aspect of the present disclosure, there is provided a seat belt retractor including: a housing including a pair of side walls facing each other; a winding drum configured to wind up a webbing, the winding drum being housed between the pair of side walls so as to be rotatable in a winding direction and a pull-out direction of the webbing; a locking base configured to rotate together with the winding drum in a normal state and to be prevented from being rotated in the pull-out direction in an emergency of a vehicle; and a pretensioner configured to rotate the winding drum in the winding direction in the emergency. The pretensioner includes: a drive wheel provided on one end side of the winding drum, the drive wheel being configured to rotate in the winding direction together with the winding drum at least at an initial stage in the emergency; a tubular pressure container provided to the side wall on the pretensioner side, of the pair of side walls, the pressure container including a terminal end portion opened at a position adjacent to the drive wheel and a base end portion provided with a gas generator; and a moving member housed in the pressure container in a normal state, the moving member being configured to, in the emergency, be engaged with the drive wheel while being pushed out in an opening direction of the terminal end portion from the pressure container by gas generated from the gas generator, so as to rotate the drive wheel in the winding direction. The pressure container is provided such that the opening direction of the terminal end portion is tilted toward the winding drum or opposite to the winding drum, with respect to a plane orthogonal to an axial direction of the winding drum. When the pretensioner is activated, the moving member moves the locking base, the drive wheel, and the winding drum to the opening direction side of the terminal end portion of the pressure container in the axial direction of the winding drum, and brings one of the locking base, the drive wheel, and the winding drum into contact with a restricting member that is a part of the housing or that is attached to the housing.

According to the present disclosure, there is provided a seat belt retractor that can stabilize a retraction force for a webbing by a pretensioner.

### BRIEF DESCRIPTION OF THE DRAWINGS

FIG. 1 is a perspective view of a seat belt retractor according to an embodiment;

FIG. 2 is an exploded perspective view of the seat belt retractor illustrated in FIG. 1;

FIG. 3 is a sectional view of the seat belt retractor illustrated in FIG. 1;

FIG. 4 is a sectional view along line IV-IV in FIG. 3;

FIG. 5 is a sectional view along line V-V in FIG. 3;

FIG. 6 is a sectional view along line VI-VI in FIG. 4;

FIG. 7 is an exploded perspective view of a part of a winding drum unit;

FIG. 8 is an exploded perspective view of the rest of the winding drum unit and a synchronized gear;

FIG. 9 is a perspective view of a winding drum;

FIG. 10 is a perspective view of a drive wheel;

FIG. 11 is a sectional view of a locking base;

FIG. 12 is an exploded perspective view of the locking base and a lock member;

FIG. 13 is an exploded perspective view of the locking base and the lock member as viewed from an opposite side;

FIG. 14A illustrates a state of a return spring when the lock member is located at a non-engagement position, and FIG. 14B illustrates a state of the return spring when the lock member is located at an engagement position;

FIG. 15 is a sectional view of a part of a seat belt retractor according to a first modification;

FIG. 16 is a sectional view of a part of a seat belt retractor according to a second modification;

FIG. 17 is a sectional view of a seat belt retractor according to a third modification, corresponding to FIG. 6;

FIG. 18 is a sectional view of a part of the seat belt retractor according to the third modification;

FIG. 19 is a sectional view of a part of a seat belt retractor according to a fourth modification; and

FIG. 20 is a sectional view of a conventional seat belt retractor.

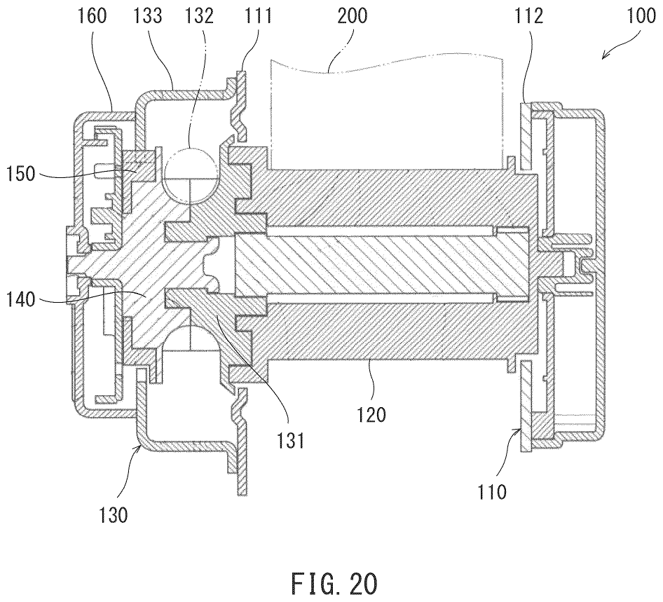

### DESCRIPTION OF THE PREFERRED EMBODIMENTS

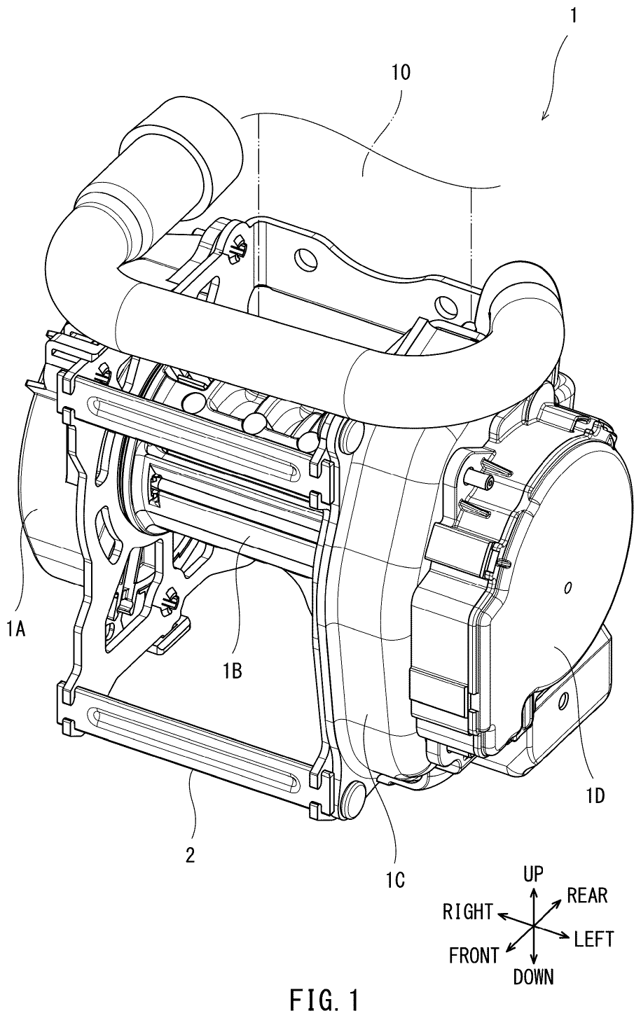

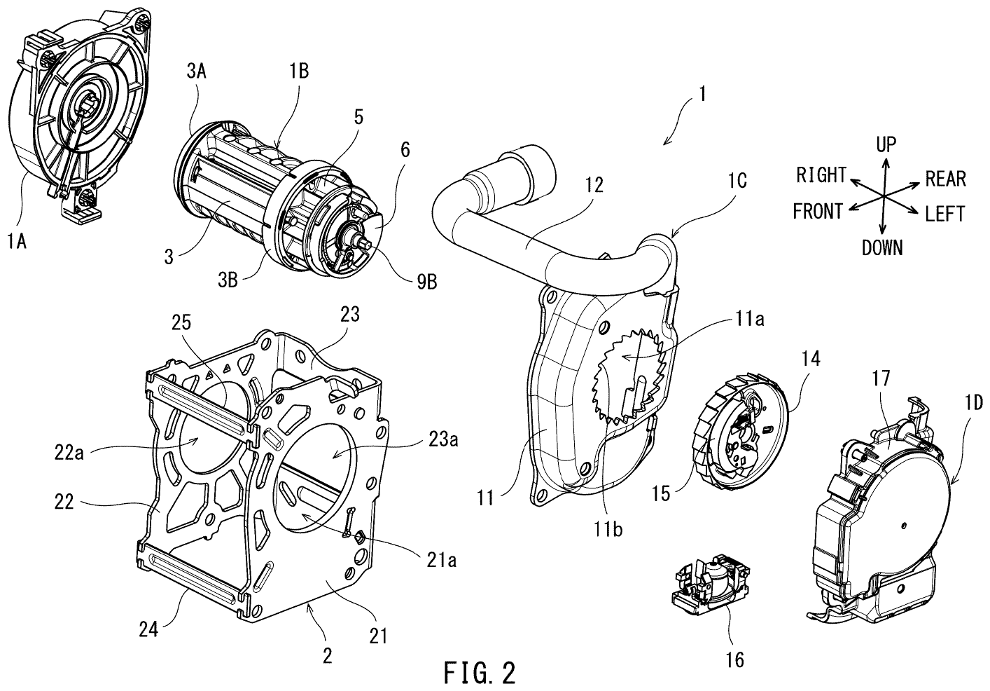

FIGS. 1 and 2 illustrate a seat belt retractor 1 according to an embodiment. The seat belt retractor 1 is configured to prevent a webbing 10 which is a seat belt from being pulled out in an emergency such as vehicle collision.

Specifically, the seat belt retractor 1 includes a housing 2, a winding spring unit 1A, a winding drum unit 1B, a pretensioner 1C, and a lock unit 1D. The winding drum unit 1B includes a winding drum 3 configured to wind up the webbing 10, and the housing 2 includes a first side wall 21 and a second side wall 22 that face each other in an axial direction of the winding drum 3.

The winding drum 3 is housed between the first side wall 21 and the second side wall 22 so as to be rotatable in a winding direction and a pull-out direction of the webbing 10. The housing 2 includes a back plate 23 that is formed by sheet metal processing together with the first side wall 21 and the second side wall 22, and that is perpendicular to the first side wall 21 and the second side wall 22. However, the back plate 23 need not be formed by sheet metal processing together with the first side wall 21 and the second side wall 22, and the first side wall 21 and the second side wall 22 that are separated from the back plate 23 may be attached to the back plate 23.

Hereinafter, for convenience of description, the axial direction of the winding drum 3 is referred to as a left-right direction (a first side wall 21 side is referred to as a leftward direction, and a second side wall 22 side is referred to as a rightward direction), and a thickness direction of the back plate 23 is referred to as a front-rear direction (a side of the side walls 21 and 22 is referred to as a forward direction, and an opposite side is referred to as a rearward direction). As illustrated in FIGS. 1 and 2, one side of a direction orthogonal to the left-right direction and the front-rear direction is referred to as an upward direction, and the other side of the direction orthogonal to the left-right direction and the front-rear direction is referred to as a downward direction.

Lower portions and upper portions of front sides of the first side wall 21 and the second side wall 22 of the housing 2 are connected by connecting bars 24 and 25. The first side wall 21 and the second side wall 22 are respectively provided with openings 21a and 22a through which the winding drum 3 is inserted. In addition, the back plate 23 is provided with an opening 23a through which the winding drum 3 is exposed.

The winding spring unit 1A is attached to the second side wall 22 of the housing 2, and the pretensioner 1C is attached to the first side wall 21 of the housing 2. The lock unit 1D is attached to the pretensioner 1C.

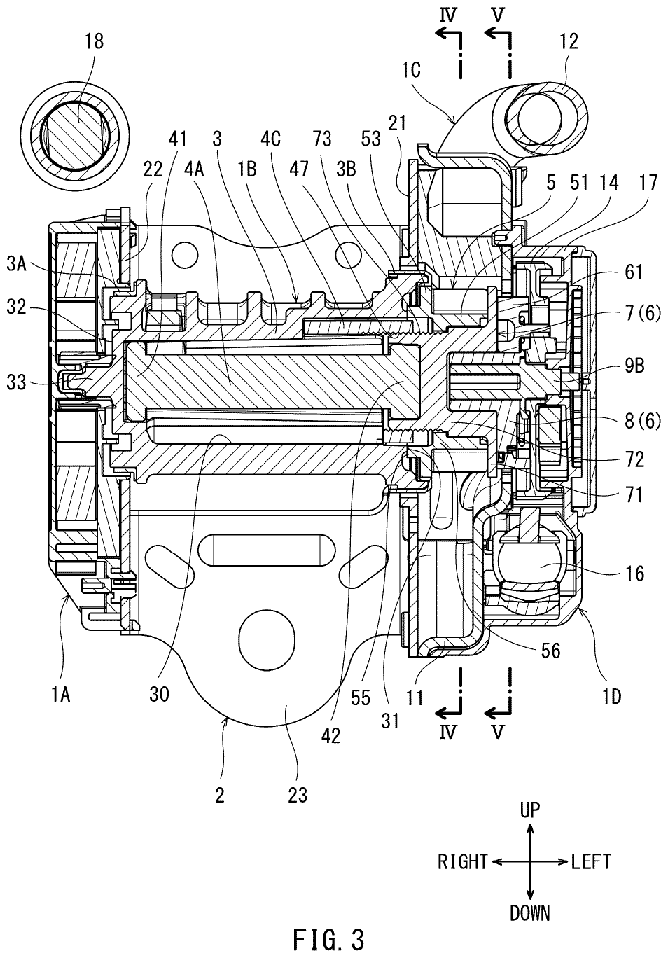

As illustrated in FIG. 3, the winding drum 3 includes a first end surface 31 on a side of the first side wall 21 of the housing 2, and a second end surface 32 on a side of the second side wall 22 of the housing 2. In the present embodiment, the winding drum 3 includes a shaft portion 33 that protrudes from the second end surface 32 in the rightward direction, and the shaft portion 33 is rotatably supported by the winding spring unit 1A. However, a torsion bar 4A to be described later may penetrate the winding drum 3, and a right end portion of the torsion bar 4A may be rotatably supported by the winding spring unit 1A. Since a configuration of the winding spring unit 1A is known, a detailed description thereof will be omitted.

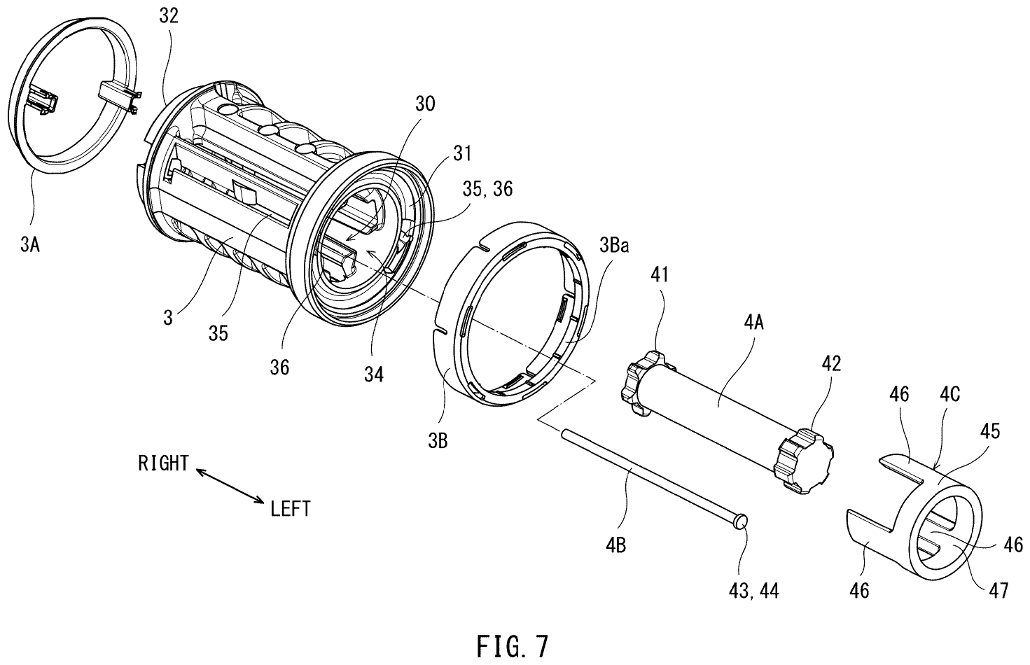

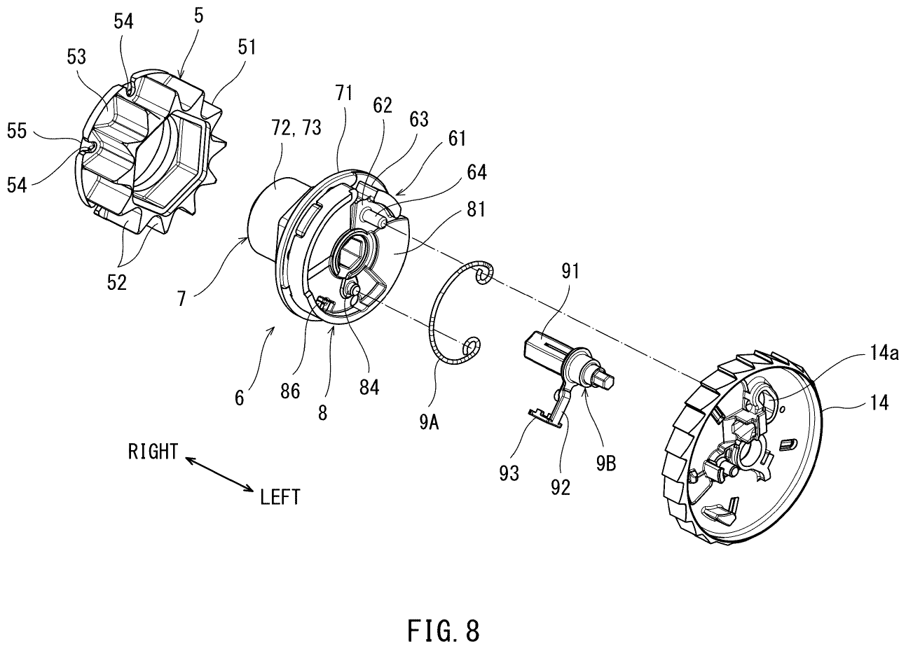

As illustrated in FIGS. 7 and 8, the winding drum unit 1B includes a bush 3A, a bearing 3B, the torsion bar 4A, an impact energy absorbing wire 4B, a stopper member 4C, a drive wheel 5, a locking base 6, a return spring 9A, and a rotation shaft 9B, in addition to the winding drum 3. The drive wheel 5 is also a component of the pretensioner 1C. In other words, the drive wheel 5 is included also in the pretensioner 1C.

The bush 3A and the bearing 3B are emergency means for smoothly rotating the winding drum 3 even when a relative position of the winding drum 3 with respect to the housing 2 is shifted in the emergency of the vehicle. As illustrated in FIG. 3, the bush 3A is attached to a right end portion of the winding drum 3, which is positioned in the opening 22a of the second side wall 22, and the bearing 3B is attached to a left end portion of the winding drum 3, which is positioned in the opening 21a of the first side wall 21. Further, the bearing 3B includes a folded portion 3Ba (see FIG. 7) that is folded back to an inner side of the left end portion of the winding drum 3, and that is configured to slide with the drive wheel 5 in a case where the winding drum 3 and the locking base 6 are rotated relative to each other.

The winding drum 3 has a center hole 30 extending along a center axis of the winding drum 3. In the present embodiment, the center hole 30 is bottomed and is opened only to the first end surface 31. However, in a case where the torsion bar 4A penetrates the winding drum 3 as described above, the center hole 30 may be opened not only in the first end surface 31 but also in the second end surface 32.

The torsion bar 4A is inserted into the center hole 30 of the winding drum 3. The locking base 6 described above is disposed to face the first end surface 31 of the winding drum 3. The torsion bar 4A includes one end side, opposite to the locking base 6, coupled to the winding drum 3 without being rotatable relative to the winding drum 3, and the other end side coupled to the locking base 6 without being rotatable relative to the locking base 6. Therefore, the locking base 6 rotates together with the winding drum 3 in a normal state.

More specifically, the torsion bar 4A includes spline-shaped coupling portions 41 and 42 on the one end side and the other end side, respectively. The bottom of the center hole 30 of the winding drum 3 includes a spline-shaped recess for coupling with the coupling portion 41, and the coupling portion 41 is fitted into the recess.

The torsion bar 4A is configured to be plastically deformed in a case where a pull-out force of the webbing 10 exceeds a predetermined value in a state where the locking base 6 is prevented from being rotated in the pull-out direction, so as to absorb impact energy while allowing the relative rotation between the winding drum 3 and the locking base 6. In other words, at an initial stage in the emergency of the vehicle before the torsion bar 4A starts to be plastically deformed, the locking base 6 and the drive wheel 5 attached to the locking base 6 rotate in the winding direction of the webbing 10 together with the winding drum 3.

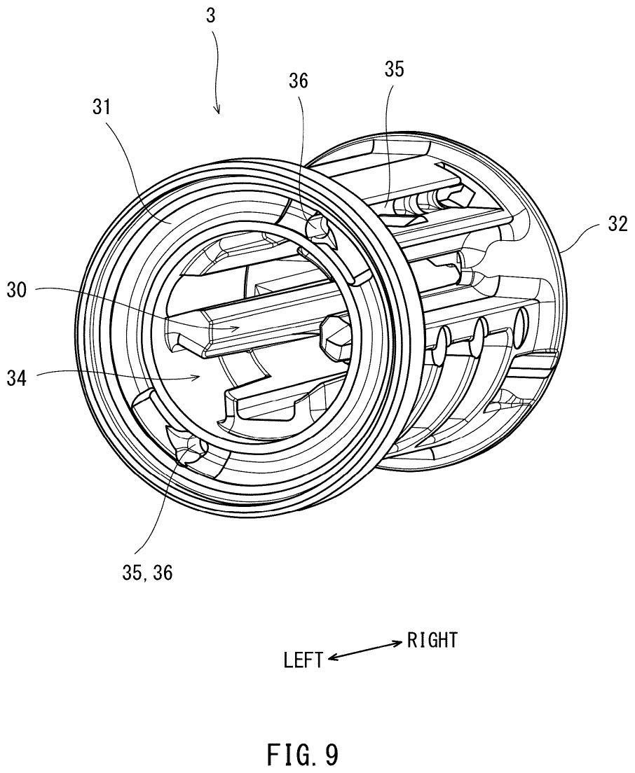

The impact energy absorbing wire 4B is configured to absorb impact energy at an initial stage when the winding drum 3 and the locking base 6 rotate relative to each other. In the present embodiment, as illustrated in FIG. 9, the winding drum 3 is provided with two slots 35 opened in the first end surface 31. In the present embodiment, each slot 35 has a groove shape recessed obliquely from an outer circumferential surface of the winding drum 3. However, the slot 35 may be a hole extending in the axial direction of the winding drum 3. The number of slots 35 may be one.

The impact energy absorbing wire 4B is housed in one of the slots 35 in a state where a head portion 43 (see FIG. 7) protrudes from the opening 36 of the slot 35. The impact energy absorbing wire 4B is configured to be pulled out from the opening 36 while being plastically deformed in a case where the winding drum 3 and the locking base 6 are relatively rotated, so as to absorb the impact energy. The impact energy absorbing wire 4B may be omitted.

The stopper member 4C defines an allowable amount of the relative rotation between the winding drum 3 and the locking base 6 in a case where the torsion bar 4A absorbs the impact energy. The stopper member 4C is held in the center hole 30 of the winding drum 3 without being rotatable relative to the winding drum 3 and so as to be movable in the left-right direction.

As illustrated in FIG. 7, the stopper member 4C has a tubular shape through which the torsion bar 4A is inserted. The stopper member 4C is formed with a female screw 47 on an inner circumferential surface of the stopper member 4C.

In the present embodiment, the stopper member 4C includes an annular portion 45, and three claw portions 46 that protrude from the annular portion 45 in the rightward direction. On the other hand, the center hole 30 of the winding drum 3 includes three guide grooves 34. Since the respective three claw portions 46 are fitted into the three guide grooves 34, the stopper member 4C is held by the winding drum 3 without being rotatable relative to the winding drum 3 and so as to be movable in the left-right direction. However, instead of the stopper member 4C including the claw portions 46, a cross-sectional shape of an outer shape of the stopper member 4C and a cross-sectional shape of a left end portion of the center hole 30 of the winding drum 3 may be polygonal.

As illustrated in FIGS. 3 and 8, the locking base 6 has a male screw 73 onto which the female screw 47 of the stopper member 4C is screwed. In addition, the drive wheel 5 having an annular shape is attached to the locking base 6. In other words, the drive wheel 5 is provided on one end side (the left end side in the present embodiment) of the winding drum 3 via the locking base 6.

In the present embodiment, as illustrated in FIG. 3, during the relative rotation between the winding drum 3 and the locking base 6, the stopper member 4C moves from a position at which the stopper member 4C is separated from the drive wheel 5 to a position at which the stopper member 4C comes into contact with the drive wheel 5, whereby the relative rotation between the winding drum 3 and the locking base 6 is restricted to a predetermined amount.

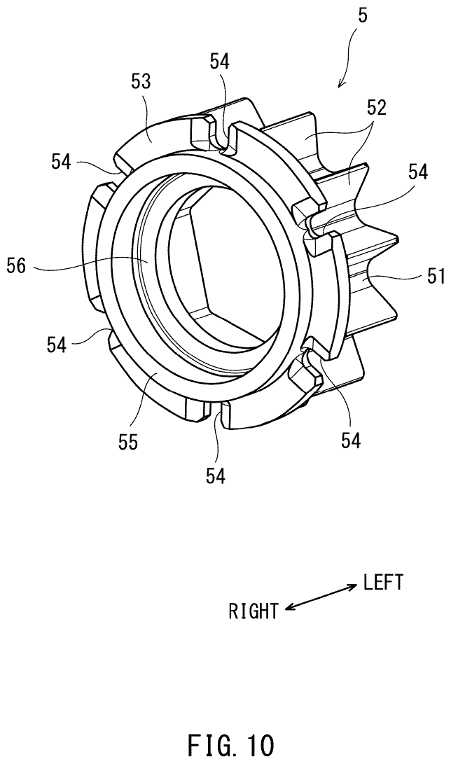

As illustrated in FIGS. 8 and 10, the drive wheel 5 includes a main body portion 51 having a fitting hole with a hexagonal cross-sectional shape, a plurality of engaging teeth 52 formed on an outer circumferential surface of the main body portion 51, an annular flange portion 53 that protrudes radially outward from the main body portion 51 on a right side of the engaging teeth 52, and a ring-shaped rib 55 that protrudes rightward from the flange portion 53. An annular flange portion 56 protrudes from an inner circumferential surface of the main body portion 51. The flange portion 56 is a part to come into contact with the stopper member 4C.

As illustrated in FIG. 3, the flange portion 53 of the drive wheel 5 faces the first end surface 31 of the winding drum 3. The flange portion 53 includes a plurality of (in the present embodiment, six as illustrated in FIG. 10) holding portions 54. The head portion 43 of the impact energy absorbing wire 4B described above is attached to one of the holding portions 54.

In the present embodiment, the holding portions 54 are grooves that are opened radially outward. The head portion 43 of the impact energy absorbing wire 4B includes a coming-off prevention portion 44 (see FIG. 7) that is located on a side of the flange portion 53 opposite to the winding drum 3, and that has a diameter larger than a width of the groove that is the holding portion 54. However, the holding portions 54 may be holes that penetrate the flange portion 53.

As illustrated in FIG. 3, in the present embodiment, the drive wheel 5 comes into contact with the first end surface 31 of the winding drum 3 by the rib 55. The impact energy absorbing wire 4B is pulled out from the opening 36 of the slot 35 while being wound around the rib 55. In a case where the winding drum 3 and the locking base 6 are rotated relative to each other, the winding drum 3 and the drive wheel 5 are rotated relative to each other while the rib 55 of the drive wheel 5 comes into contact with the first end surface 31 of the winding drum 3 in the axial direction of the winding drum 3, and while an outer circumference of the flange portion 53 of the drive wheel 5 comes into contact with the folded portion 3Ba of the bearing 3B attached to the winding drum 3 in a radial direction of the winding drum 3.

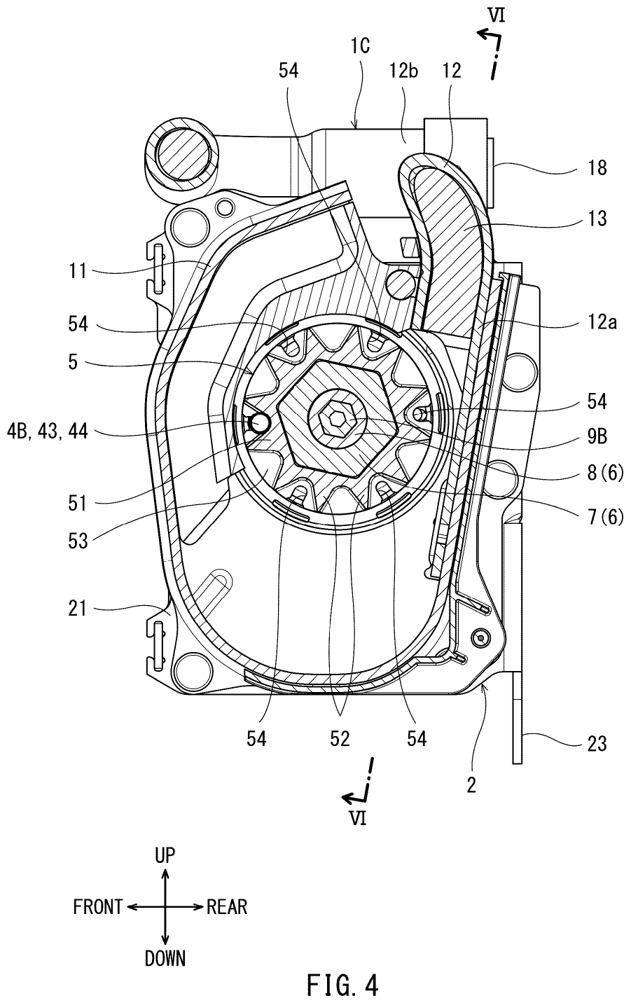

The pretensioner 1C rotates the winding drum 3 in the winding direction of the webbing 10 via the locking base 6 and the torsion bar 4A by rotating the drive wheel 5 in the winding direction of the webbing 10 in the emergency of the vehicle. As illustrated in FIGS. 2 to 4, the pretensioner 1C includes a cover member 11 attached to the first side wall 21 of the housing 2, a tubular pressure container 12 extending while bending from the cover member 11, and a moving member 13 housed in the pressure container 12 in a normal state.

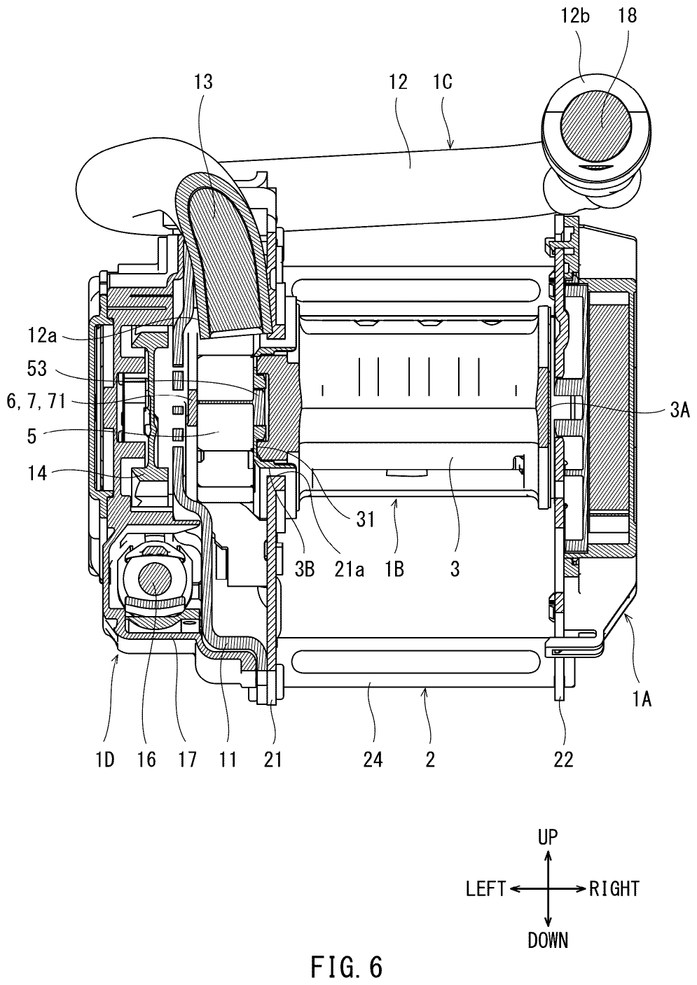

As illustrated in FIG. 6, the pressure container 12 is provided to the cover member 11 and the first side wall 21 on the pretensioner 1C side. The cover member 11 houses the drive wheel 5 and a terminal end portion 12a of the pressure container 12. The terminal end portion 12a of the pressure container 12 is opened at a position adjacent to the drive wheel 5, and a gas generator 18 is provided in a base end portion 12b of the pressure container 12.

In the present embodiment, the pressure container 12 is provided such that an opening direction of the terminal end portion 12a is tilted toward the winding drum 3 with respect to a plane orthogonal to the axial direction of the winding drum 3. Therefore, the flange portion 53 of the drive wheel 5 is provided on the opening direction side of the terminal end portion 12a of the pressure container 12 in the axial direction of the winding drum 3 with respect to the engaging teeth 52. For example, the tilt angle of the opening direction of the terminal end portion 12a with respect to the plane orthogonal to the axial direction of the winding drum 3 is in a range of 5 to 15 degrees.

In the present embodiment, the moving member 13 has a rod shape, and is plastically deformed by digging of the engaging teeth 52 of the drive wheel 5. However, the moving member 13 may be implemented by a plurality of divided bodies (for example, spheres) arranged at the same pitch as the engaging teeth 52 of the drive wheel 5.

In the emergency of the vehicle, the moving member 13 is engaged with the engaging teeth 52 of the drive wheel 5 while being pushed out in the opening direction of the terminal end portion 12a from the pressure container 12 by gas generated from the gas generator 18, so as to rotate the drive wheel 5 in the winding direction of the webbing 10. As the drive wheel 5 is rotated, the locking base 6, the torsion bar 4A, and the winding drum 3 are also rotated. After the pretensioner 1C is activated, the moving member 13 is prevented from being pushed back into the pressure container 12, by the pressure of the gas in the pressure container 12, and thus the drive wheel 5 is prevented from being rotated in the pull-out direction of the webbing 10.

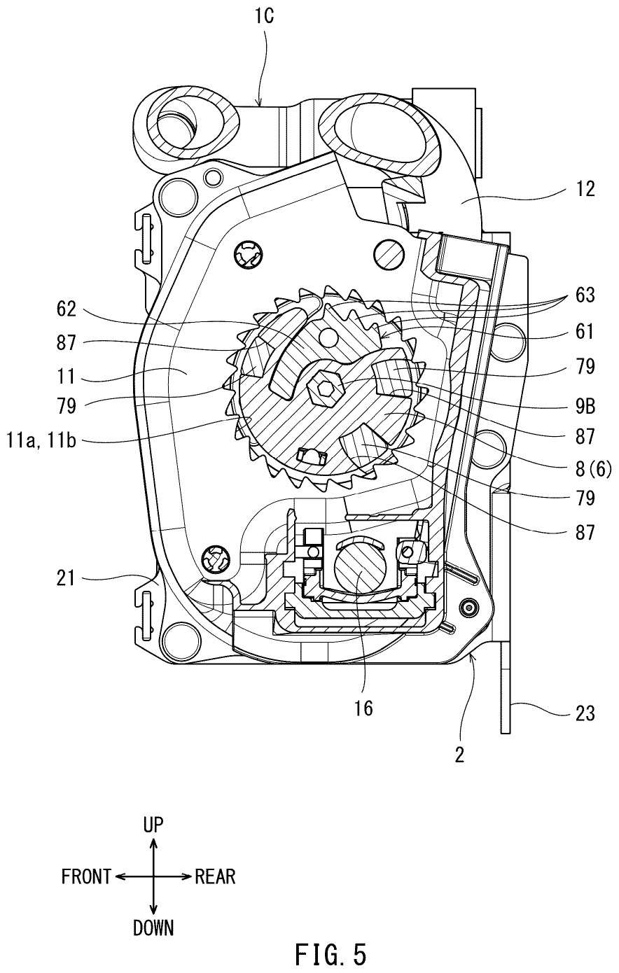

As illustrated in FIGS. 2 and 5, the cover member 11 is provided with an opening 11a through which the locking base 6 is inserted, and the opening 11a has internal teeth 11b formed on a circumferential edge of the opening 11a. On the other hand, the locking base 6 includes a pawl 61 configured to be engageable with the internal teeth 11b. The pawl 61 is engaged with the internal teeth 11b to prevent the locking base 6 from being rotated in the pull-out direction of the webbing 10 in the emergency of the vehicle.

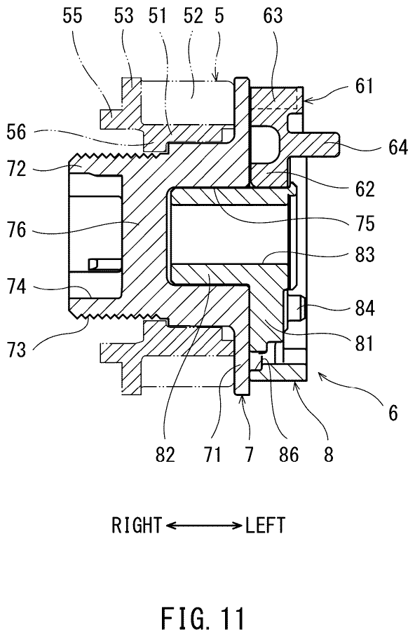

As illustrated in FIGS. 11 to 13, the locking base 6 includes a first base member 7 to which the drive wheel 5 is attached, and a second base member 8 which is attached to the first base member 7 on a side of the first base member 7 opposite to the winding drum 3 without being rotatable relative to the first base member 7. The pawl 61 is held between the first base member 7 and the second base member 8.

More specifically, the first base member 7 includes a disk-shaped first main body portion 71, and a protruding portion 72 that protrudes from the first main body portion 71 in the rightward direction. As illustrated in FIG. 3, the drive wheel 5 is disposed between the first main body portion 71 and the first end surface 31 of the winding drum 3, and the protruding portion 72 penetrates the drive wheel 5. A proximal portion of the protruding portion 72 is formed to have a hexagonal cross-sectional shape, and by fitting the proximal portion into the fitting hole of the main body portion 51 of the drive wheel 5, which also has a hexagonal cross-sectional shape, the drive wheel 5 is attached to the first base member 7 without being rotatable relative to the first base member 7. The male screw 73 described above is formed on the outer circumferential surface of the distal end side of the protruding portion 72.

The first base member 7 includes a first recess 74 that is recessed from a distal end surface of the protruding portion 72, and a second recess 75 that is coaxial with the first recess 74 and that is recessed from a surface of the first main body portion 71 on a side opposite to the drive wheel 5. The first recess 74 is a spline-shaped recess for coupling with the coupling portion 42 of the torsion bar 4A, and the coupling portion 42 is fitted into the first recess 74. In the present embodiment, the second recess 75 has a circular cross-sectional shape. In the present embodiment, the first base member 7 includes a partition 76 that separates the first recess 74 and the second recess 75. That is, the first recess 74 and the second recess 75 are bottomed.

The second base member 8 includes a plate-shaped second main body portion 81 that overlaps the first main body portion 71, and a fitting protrusion 82 that protrudes from the second main body portion 81 in the rightward direction. In the present embodiment, the second main body portion 81 includes three engagement concave portions 87, and by engaging three engagement convex portions 79 provided on the first main body portion 71 with the respective engagement concave portions 87, the second base member 8 is attached to the first base member 7 without being rotatable relative to the first base member 7. The fitting protrusion 82 has a circular cross-sectional shape, and the fitting protrusion 82 is fitted into the second recess 75. However, the second recess 75 and the fitting protrusion 82 may have a non-circular cross sectional shape, and by fitting the fitting protrusion 82 into the second recess 75, the second base member 8 may be attached to the first base member 7 without being rotatable relative to the first base member 7. In this case, the engagement concave portions 87 and the engagement convex portions 79 may be omitted.

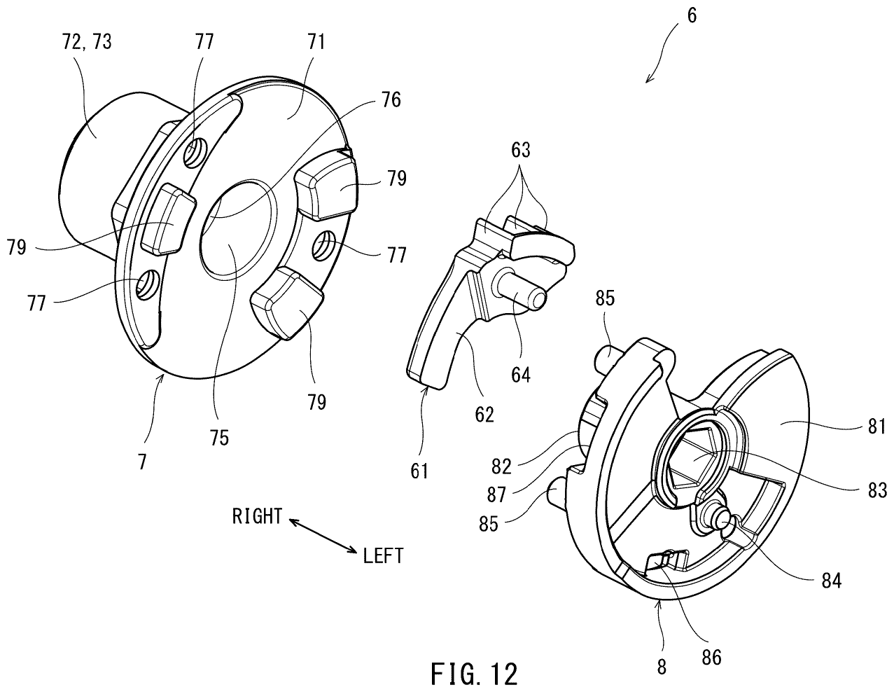

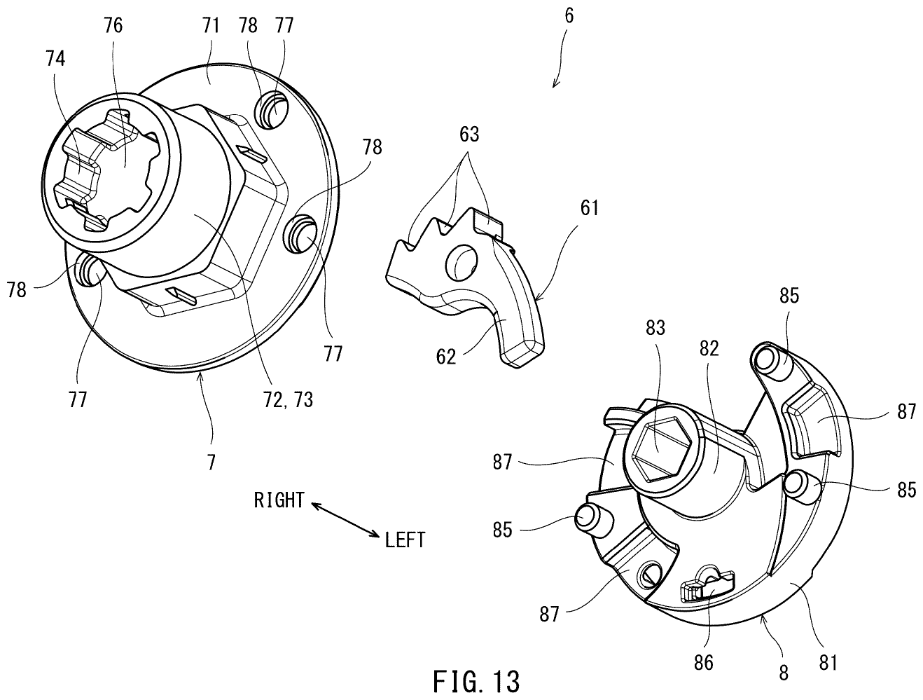

In the present embodiment, the second main body portion 81 of the second base member 8 includes three crimping protrusions 85 protruding in the rightward direction, whereas the first main body portion 71 of the first base member 7 is provided with three through holes 77 through which the crimping protrusions 85 are inserted. Crimping concave portions 78 that are coaxial with the through holes 77 and that have larger diameters than the through holes 77 are formed on a side of the first main body portion 71 opposite to the second main body portion 81. A portion of each crimping protrusion 85, which protrudes from the through hole 77, is crimped to have a larger diameter than the through hole 77 in the crimping concave portion 78 and to have an outer diameter substantially equal to an inner diameter of the crimping concave portion 78 (in FIGS. 12 and 13, the crimping protrusion 85 is drawn in a shape before crimping).

The pawl 61 includes a substantially arc-shaped and plate-shaped main body portion 62 that is held by the first main body portion 71 of the first base member 7 and the second main body portion 81 of the second base member 8, a plurality of (three in the illustrated example) engaging teeth 63 that are formed on an outer side surface of the main body portion 62 and that are configured to be engageable with the internal teeth 11b described above, and an operation shaft 64 that protrudes from the main body portion 62 in the leftward direction.

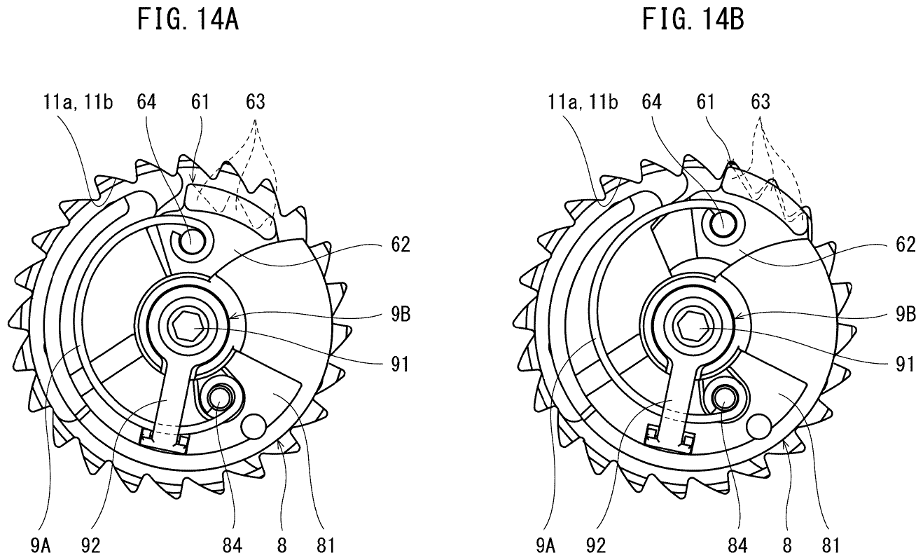

The second main body portion 81 of the second base member 8 includes a pin 84 that protrudes in the leftward direction. The return spring 9A described above has a substantially arc shape as illustrated in FIG. 8, and the return spring 9A includes one end engaged with the operation shaft 64 of the pawl 61 and the other end engaged with the pin 84. The return spring 9A is configured to maintain the pawl 61 at a non-engagement position illustrated in FIG. 14A.

The second base member 8 is provided with an engagement hole 83 that is coaxial with the fitting protrusion 82 and that is opened in the leftward direction. In the present embodiment, the engagement hole 83 penetrates the second base member 8, and is also opened in the rightward direction. The engagement hole 83 has a hexagonal cross-sectional shape.

The pawl 61 is operated by a synchronized gear 14 (see FIGS. 2 and 8). As illustrated in FIG. 2, the lock unit 1D includes a cover member 17 that houses the synchronized gear 14 and a vehicle sensor 16. The synchronized gear 14 includes a webbing sensor 15. The webbing sensor 15 is configured to be activated in a case where the webbing 10 is rapidly pulled out, whereby the synchronized gear 14 is prevented from being rotated in the pull-out direction. The vehicle sensor 16 is configured to be activated in a case where an acceleration of the vehicle changes largely, whereby the synchronized gear 14 is prevented from being rotated in the pull-out direction.

In a case where the synchronized gear 14 is prevented from being rotated in the pull-out direction, the locking base 6 is rotated relative to the synchronized gear 14 together with the winding drum 3, and the operation shaft 64 of the pawl 61 is operated in a guide hole 14a (see FIG. 8) of the synchronized gear 14, whereby the pawl 61 moves from the non-engagement position illustrated in FIG. 14A to an engagement position illustrated in FIG. 14B.

As illustrated in FIG. 8, the rotation shaft 9B described above includes a rod-shaped main body portion 91, and an arm 92 extending radially outward from the main body portion 91. A right side portion of the main body portion 91 has a hexagonal cross-sectional shape, and the right side portion is fitted into and engaged with the engagement hole 83 of the second base member 8. The arm 92 is for restraining the return spring 9A, and a hook 93 provided at a distal end of the arm 92 is engaged with an engagement hole 86 provided in the second main body portion 81 of the second base member 8. As illustrated in FIG. 3, a left side portion of the rotation shaft 9B penetrates the synchronized gear 14 and is rotatably supported by the cover member 17 of the lock unit 1D.

Next, an effect owing to the tilt of the opening direction of the terminal end portion 12a of the pressure container 12 will be described. When the pretensioner 1C is activated, the moving member 13 pushed out in the opening direction of the terminal end portion 12a from the pressure container 12 comes into contact with the flange portion 53 of the drive wheel 5, and presses the flange portion 53 to the opening direction side of the terminal end portion 12a of the pressure container 12 in the axial direction of the winding drum 3, i.e., to the right side. The moving member 13 comes into contact with also the bearing 3B located radially outside the flange portion 53 and presses the first end surface 31 of the winding drum 3 to the right side via the bearing 3B. As a result, the drive wheel 5, the locking base 6, and the winding drum 3 are moved rightward by the moving member 13, so that the right end portion of the winding drum 3 comes into contact with the second side wall 22 of the housing 2 via the bush 3A.

That is, the second side wall 22, which is a part of the housing 2, serves as a restricting member configured to restrict movement of the drive wheel 5, the locking base 6, and the winding drum 3 in the axial direction of the winding drum 3. The bush 3A is a friction reduction element interposed between the winding drum 3 and the second side wall 22 and configured to reduce a sliding resistance due to contact between the winding drum 3 and the second side wall 22. The friction reduction element has only to exhibit better slidability than in a case where the winding drum 3 and the second side wall 22 slide on each other. In a case where the housing 2 and the winding drum 3 are made of metal (e.g., steel or an aluminum alloy) as in the present embodiment, the bush 3A is made of a material (e.g., fluororesin, polyacetal, polypropylene, or the like) that exhibits better slidability than in a case where metals slide on each other.

As described above, in the seat belt retractor 1 according to the present embodiment, when the pretensioner 1C is activated, the moving member 13 brings the winding drum 3 into contact with the restricting member which is the second side wall 22 of the housing 2 via the bush 3A, and thus movement restriction states of the locking base 6, the drive wheel 5, and the winding drum 3 in the axial direction of the winding drum 3 are defined. Therefore, a retraction force for the webbing 10 by the pretensioner 1C can be stabilized.

In addition, in the present embodiment, the moving member 13 presses the flange portion 53 of the drive wheel 5, and also presses the first end surface 31 of the winding drum 3 via the bearing 3B. Thus, by a pressing force of the moving member 13 to the flange portion 53 of the drive wheel 5 and the first end surface 31 of the winding drum 3, the winding drum 3 can be brought into contact with the restricting member via the bush 3A.

Further, in the present embodiment, the restricting member is the second side wall 22 of the housing 2 and thus the existing component serves as the restricting member. Therefore, it is not necessary to add a new component as the restricting member. In addition, the housing 2 having a sufficient strength can be used as the restricting member.

In addition, in the present embodiment, the bush 3A is used as the friction reduction element, and therefore friction between the winding drum 3 and the restricting member is reduced when the pretensioner 1C is activated. Thus, a retraction force for the webbing 10 by the pretensioner 1C can be sufficiently ensured. Further, when the friction reduction element is the bush 3A, the friction reduction element can be configured in a simplified manner.

### Modifications

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

For example, the locking base 6 need not hold the pawl 61, and may be a ratchet gear with which the pawl held by the housing 2 is engaged.

The pretensioner 1C may be provided on a side of the winding drum 3 opposite to the locking base 6, i.e., at the second side wall 22 of the housing 2. In this case, the drive wheel 5 may be provided on the right end side of the winding drum 3 via a clutch. The clutch provided as described above is configured to allow the drive wheel 5 to rotate relative to the winding drum 3 in a normal state and allow the drive wheel 5 to rotate integrally with the winding drum 3 in the emergency of the vehicle. That is, the drive wheel 5 may rotate in the winding direction of the webbing 10 together with the winding drum 3, at least at an initial stage in the emergency of the vehicle.

Even in the case where the pretensioner 1C is provided to the first side wall 21 as in the above embodiment, a clutch may be provided between the locking base 6 and the drive wheel 5 so that the drive wheel 5 rotates relative to the locking base 6 in a normal state and the drive wheel 5 rotates integrally with the locking base 6 in the emergency of the vehicle.

In contrast to the above embodiment, the pretensioner 1C may be provided inside the housing 2 (between the first side wall 21 and the second side wall 22). For example, the cover member 11 of the pretensioner 1C may be attached to an inner surface of the first side wall 21, and internal teeth to be engaged with the pawl 61 may be provided to the first side wall 21.

The drive wheel 5 may not have the flange portion 53, and when the pretensioner 1C is activated, the moving member 13 may come into contact with the first end surface 31 of the winding drum 3 and press the first end surface 31 to the opening direction side of the terminal end portion 12a of the pressure container 12 in the axial direction of the winding drum 3, i.e., to the right side. With this configuration, by a pressing force of the moving member 13 to the first end surface 31 of the winding drum 3, the winding drum 3 can be brought into contact with the second side wall 22 which is the restricting member.

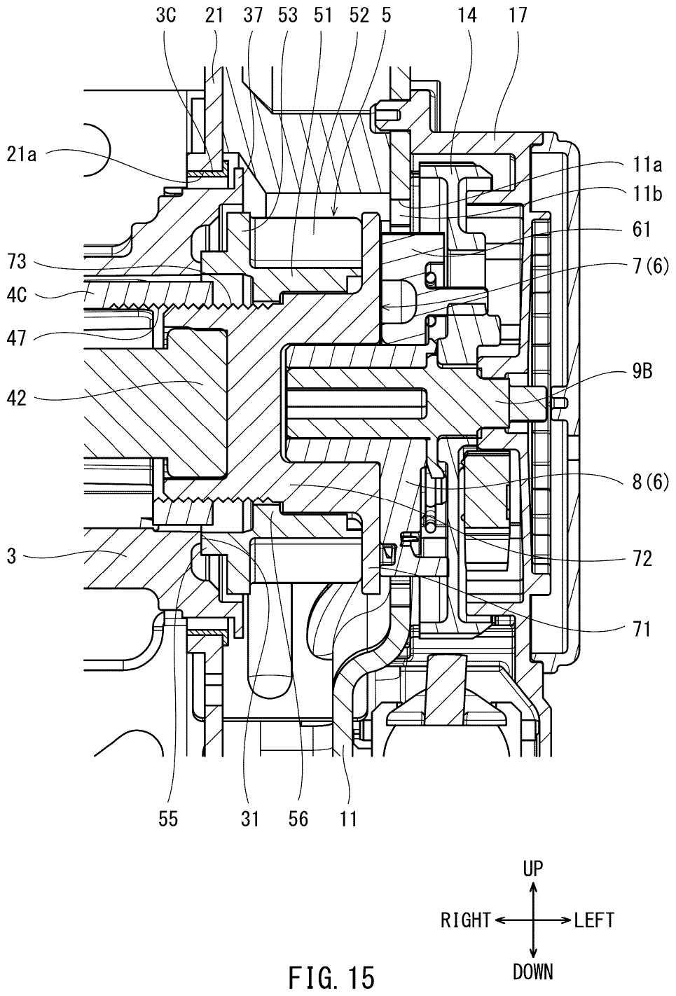

As in a seat belt retractor according to a first modification shown in FIG. 15, the winding drum 3 may have, at a left end portion thereof, a flange portion 37 located at a position on the left side relative to the first side wall 21 and expanding radially outward, and a bush 3C may be attached to the opening 21a of the first side wall 21. The flange portion 37 faces a peripheral portion of the opening 21a of the first side wall 21 in the left-right direction. That is, in the first modification, the first side wall 21, which is a part of the housing 2, is the restricting member, and the bush 3C is the friction reduction element interposed between the winding drum 3 and the restricting member.

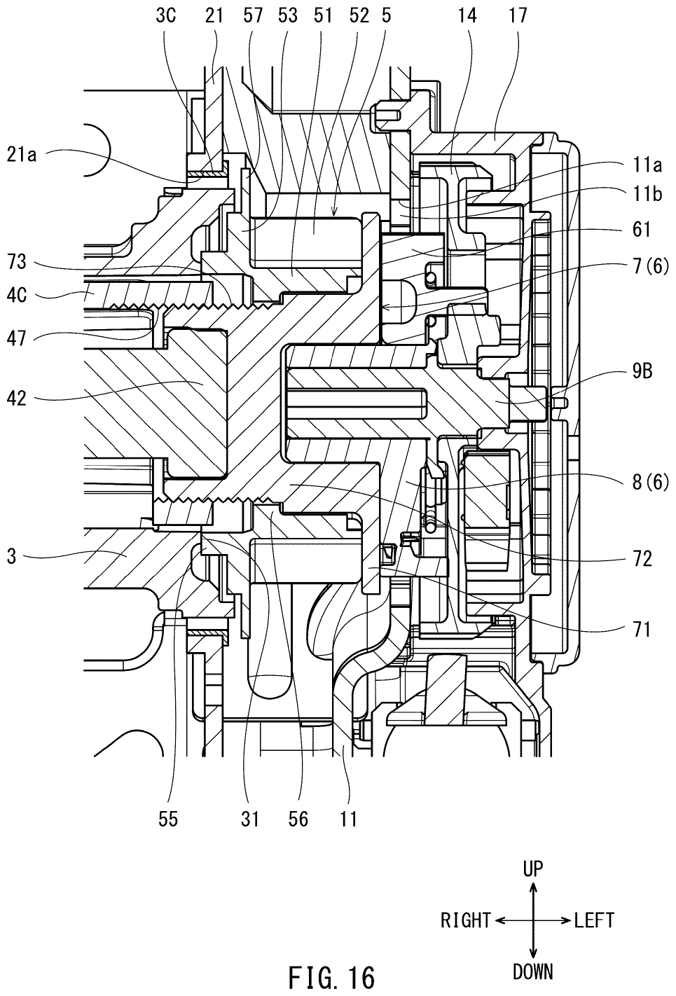

Alternatively, as in a seat belt retractor according to a second modification shown in FIG. 16, the drive wheel 5 may have a flange portion 57 expanding radially outward so as to face a peripheral portion of the opening 21a of the first side wall 21 in the left-right direction, and the bush 3C may be attached to the opening 21a of the first side wall 21. That is, in the second modification, the first side wall 21, which is a part of the housing 2, is the restricting member, and the bush 3C is the friction reduction element interposed between the drive wheel 5 and the restricting member.

In FIG. 16, when the pretensioner 1C is activated, the moving member 13 pushed out in the opening direction of the terminal end portion 12a from the pressure container 12 comes into contact with the flange portion 53 and the flange portion 57 of the drive wheel 5, and presses the flange portion 53 and the flange portion 57 to the opening direction side of the terminal end portion 12a of the pressure container 12 in the axial direction of the winding drum 3, i.e., to the right side. As a result, the drive wheel 5, the locking base 6, and the winding drum 3 are moved rightward by the moving member 13, so that the flange portion 57 comes into contact with the first side wall 21 via the bush 3C.

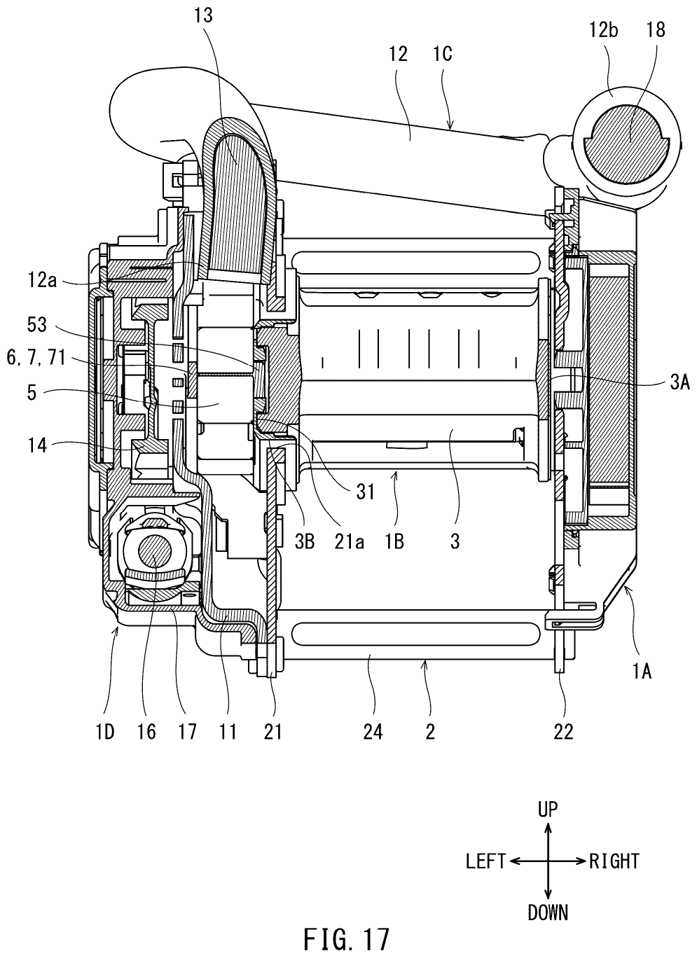

As in a seat belt retractor according to a third modification shown in FIG. 17, the pressure container 12 may be provided such that the opening direction of the terminal end portion 12a is tilted opposite to the winding drum 3 with respect to a plane orthogonal to the axial direction of the winding drum 3, i.e., tilted leftward.

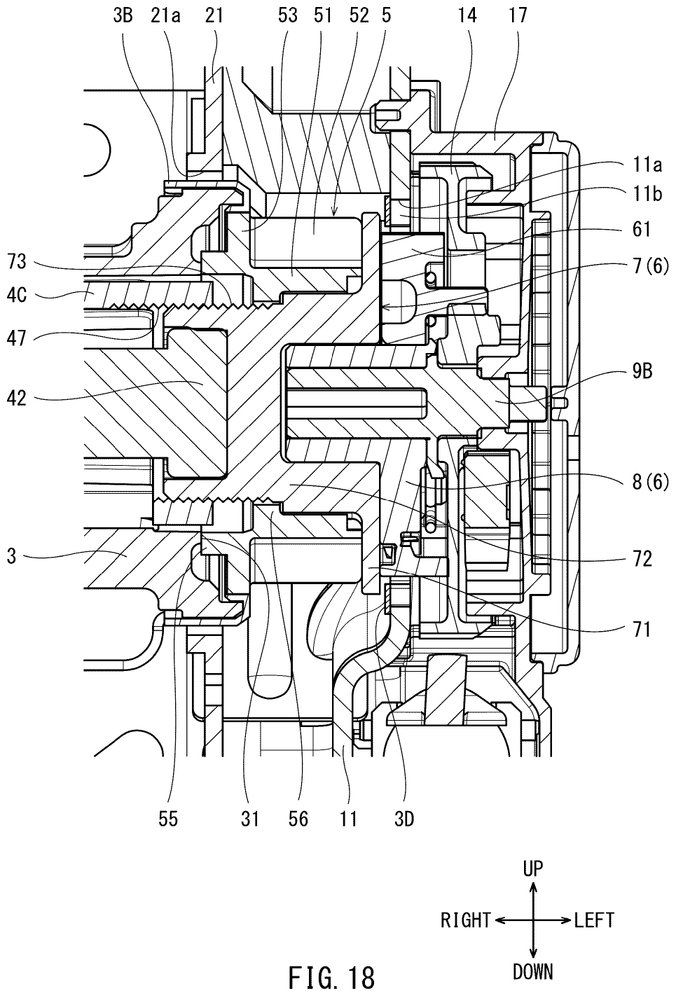

In this case, as illustrated in FIG. 18, an outer peripheral edge located on the radially outer side relative to the protruding portion 72 in the first main body portion 71 of the first base member 7 of the locking base 6 can be regarded as a flange portion provided on the opening direction side of the terminal end portion 12a of the pressure container 12 relative to the engaging teeth 52 of the drive wheel 5 in the axial direction of the winding drum 3, i.e., provided on the left side.

A part located on the radially outer side relative to the protruding portion 72 in the first main body portion 71 of the first base member 7 of the locking base 6 faces a peripheral edge of the opening 11a of the cover member 11 of the pretensioner 1C in the left-right direction. That is, the cover member 11 serves as the restricting member configured to restrict movement of the drive wheel 5, the locking base 6, and the winding drum 3 in the axial direction of the winding drum 3.

Further, on the right surface of the peripheral edge of the opening 11a of the cover member 11, coating 3D is provided as a friction reduction element configured to reduce a sliding resistance due to contact between the locking base 6 and the cover member 11. The coating 3D is made of a material (e.g., a material containing fluororesin, molybdenum disulfide, or graphite) having excellent slidability.

In FIG. 18, when the pretensioner 1C is activated, the moving member 13 pushed out in the opening direction of the terminal end portion 12a from the pressure container 12 comes into contact with the outer peripheral edge (flange portion) of the first main body portion 71 of the first base member 7 of the locking base 6, and presses the outer peripheral edge of the first main body portion 71 to the opening direction side of the terminal end portion 12a of the pressure container 12 in the axial direction of the winding drum 3, i.e., to the left side. As a result, the drive wheel 5, the locking base 6, and the winding drum 3 are moved leftward by the moving member 13, so that the outer peripheral edge of the first main body portion 71 comes into contact with the cover member 11 via the coating 3D.

That is, also in the third modification shown in FIG. 18, as in the above embodiment, movement restriction states of the locking base 6, the drive wheel 5, and the winding drum 3 in the axial direction of the winding drum 3 are defined. Therefore, a retraction force for the webbing 10 by the pretensioner 1C can be stabilized.

In addition, in the third modification, the moving member 13 presses the outer peripheral edge of the first main body portion 71 of the first base member 7. Thus, by a pressing force of the moving member 13 to the outer peripheral edge of the first main body portion 71, the outer peripheral edge of the first main body portion 71 can be brought into contact with the cover member 11 (restricting member) via the coating 3D.

Further, in the third modification, the restricting member is the cover member 11 and thus the existing component serves as the restricting member. Therefore, it is not necessary to add a new component as the restricting member. In addition, the cover member 11 having a sufficient strength can be used as the restricting member.

In addition, in the third modification, the coating 3D is used as the friction reduction element, and therefore friction between the locking base 6 and the restricting member is reduced when the pretensioner 1C is activated. Thus, a retraction force for the webbing 10 by the pretensioner 1C can be sufficiently ensured. Further, when the friction reduction element is the coating 3D, the friction reduction element can be configured in a simplified manner.

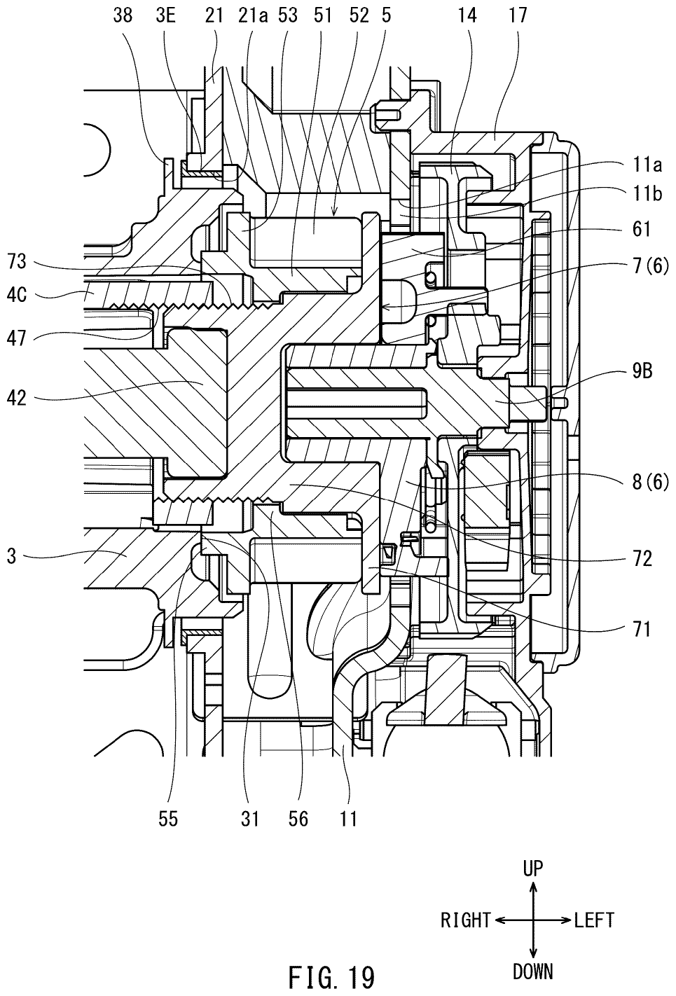

In a case where the pressure container 12 is provided such that the opening direction of the terminal end portion 12a is tilted leftward, as in a seat belt retractor according to a fourth modification shown in FIG. 19, the winding drum 3 may have, at a left end portion thereof, a flange portion 38 located on the right side relative to the first side wall 21 and expanding radially outward, and a bush 3E may be attached to the opening 21a of the first side wall 21. The flange portion 38 faces a peripheral portion of the opening 21a of the first side wall 21 in the left-right direction. That is, in the fourth modification, the first side wall 21, which is a part of the housing 2, is the restricting member, and the bush 3E is the friction reduction element interposed between the winding drum 3 and the restricting member.

In the above embodiment, the bush 3A may be provided to the second side wall 22 instead of the right end portion of the winding drum 3. In the first modification, the bush 3C may be provided to the left end portion of the winding drum 3 instead of the first side wall 21. In the second modification, the bush 3C may be provided to the drive wheel 5 instead of the first side wall 21. In the third modification, the coating 3D may be provided on a surface of the first main body portion 71 of the first base member 7 of the locking base 6 instead of a surface of the cover member 11. In the fourth modification, the bush 3E may be provided to the left end portion of the winding drum 3 instead of the first side wall 21. Further, coating may be adopted instead of a bush, or a bush may be adopted instead of coating.

When the pretensioner 1C is activated, the moving member 13 may be configured to move the drive wheel 5, the locking base 6, and the winding drum 3 toward the opening direction side of the terminal end portion 12a of the pressure container 12 in the axial direction of the winding drum 3 by only a frictional force without coming into contact with any parts other than the engaging teeth 52 of the drive wheel 5.

### Overview

As a first aspect of the present disclosure, there is provided a seat belt retractor including: a housing including a pair of side walls facing each other; a winding drum configured to wind up a webbing, the winding drum being housed between the pair of side walls so as to be rotatable in a winding direction and a pull-out direction of the webbing; a locking base configured to rotate together with the winding drum in a normal state and to be prevented from being rotated in the pull-out direction in an emergency of a vehicle; and a pretensioner configured to rotate the winding drum in the winding direction in the emergency. The pretensioner includes: a drive wheel provided on one end side of the winding drum, the drive wheel being configured to rotate in the winding direction together with the winding drum at least at an initial stage in the emergency; a tubular pressure container provided to the side wall on the pretensioner side, of the pair of side walls, the pressure container including a terminal end portion opened at a position adjacent to the drive wheel and a base end portion provided with a gas generator; and a moving member housed in the pressure container in a normal state, the moving member being configured to, in the emergency, be engaged with the drive wheel while being pushed out in an opening direction of the terminal end portion from the pressure container by gas generated from the gas generator, so as to rotate the drive wheel in the winding direction. The pressure container is provided such that the opening direction of the terminal end portion is tilted toward the winding drum or opposite to the winding drum, with respect to a plane orthogonal to an axial direction of the winding drum. When the pretensioner is activated, the moving member moves the locking base, the drive wheel, and the winding drum to the opening direction side of the terminal end portion of the pressure container in the axial direction of the winding drum, and brings one of the locking base, the drive wheel, and the winding drum into contact with a restricting member that is a part of the housing or that is attached to the housing.

According to the above configuration, when the pretensioner is activated, the moving member brings one of the locking base, the drive wheel, and the winding drum into contact with the restricting member, and thus movement restriction states of the locking base, the drive wheel, and the winding drum in the axial direction of the winding drum are defined. Therefore, a retraction force for the webbing by the pretensioner can be stabilized.

As a second aspect, according to the first aspect, the drive wheel may include engaging teeth for engagement with the moving member, and a flange portion provided on the opening direction side of the terminal end portion of the pressure container in the axial direction of the winding drum with respect to the engaging teeth, and when the pretensioner is activated, the moving member may come into contact with the flange portion, and press the flange portion to the opening direction side of the terminal end portion of the pressure container in the axial direction of the winding drum.

According to the above configuration, by a pressing force of the moving member to the flange portion of the drive wheel, one of the locking base, the drive wheel, and the winding drum can be brought into contact with the restricting member.

As a third aspect, according to the first or second aspect, when the pretensioner is activated, the moving member may come into contact with an end surface of the winding drum, and press the end surface to the opening direction side of the terminal end portion of the pressure container in the axial direction of the winding drum.

According to the above configuration, by a pressing force of the moving member to the end surface of the winding drum, one of the locking base, the drive wheel, and the winding drum can be brought into contact with the restricting member.

As a fourth aspect, according to the first or second aspect, the drive wheel may be provided on one end side of the winding drum via the locking base, and include engaging teeth for engagement with the moving member, the locking base may include a flange portion provided on the opening direction side of the terminal end portion of the pressure container in the axial direction of the winding drum with respect to the engaging teeth, and when the pretensioner is activated, the moving member may come into contact with the flange portion, and press the flange portion to the opening direction side of the terminal end portion of the pressure container in the axial direction of the winding drum.

According to the above configuration, by a pressing force of the moving member to the flange portion of the locking base, one of the locking base, the drive wheel, and the winding drum can be brought into contact with the restricting member.

As a fifth aspect, according to any one of the first to fourth aspects, the restricting member may be one of the pair of side walls of the housing.

According to the above configuration, the existing component serves as the restricting member. Therefore, it is not necessary to add a new component as the restricting member. In addition, the housing having a sufficient strength can be used as the restricting member.

As a sixth aspect, according to any one of the first to fourth aspects, the pretensioner may include a cover member that houses the drive wheel and the terminal end portion of the pressure container, and that is attached to the housing, and the restricting member may be the cover member. According to the above configuration, the existing component serves as the restricting member. Therefore, it is not necessary to add a new component as the restricting member. In addition, the cover member having a sufficient strength can be used as the restricting member.

As a seventh aspect, according to any one of the first to sixth aspects, the seat belt retractor may further include a friction reduction element configured to reduce a sliding resistance due to contact between the restricting member and the one of the locking base, the drive wheel, and the winding drum. According to the above configuration, friction between the restricting member and one of the locking base, the drive wheel, and the winding drum is reduced when the pretensioner is activated. Thus, a retraction force for the webbing by the pretensioner can be sufficiently ensured.

As an eighth aspect, according to the seventh aspect, the friction reduction element may be a bush interposed between the restricting member and the one of the locking base, the drive wheel, and the winding drum, or coating on surfaces of the locking base, the drive wheel, the winding drum, and the restricting member. According to the above configuration, the friction reduction element can be configured in a simplified manner.

What is claimed is:

1. A seat belt retractor comprising:
a housing including a pair of side walls facing each other;
a winding drum configured to wind up a webbing, the winding drum being housed between the pair of side walls so as to be rotatable in a winding direction and a pull-out direction of the webbing;
a locking base configured to rotate together with the winding drum in a normal state and to be prevented from being rotated in the pull-out direction in an emergency of a vehicle; and
a pretensioner configured to rotate the winding drum in the winding direction in the emergency, wherein
the pretensioner includes
a drive wheel provided on one end side of the winding drum, the drive wheel being configured to rotate in the winding direction together with the winding drum at least at an initial stage in the emergency,
a tubular pressure container provided to the side wall on the pretensioner side, of the pair of side walls, the pressure container including a terminal end portion opened at a position adjacent to the drive wheel and a base end portion provided with a gas generator, and
a moving member housed in the pressure container in a normal state, the moving member being configured to, in the emergency, be engaged with the drive wheel while being pushed out in an opening direction of the terminal end portion from the pressure container by gas generated from the gas generator, so as to rotate the drive wheel in the winding direction,
the pressure container is provided such that the opening direction of the terminal end portion is tilted toward the winding drum or opposite to the winding drum, with respect to a plane orthogonal to an axial direction of the winding drum, and
when the pretensioner is activated, the moving member moves the locking base, the drive wheel, and the winding drum to the opening direction side of the terminal end portion of the pressure container in the axial direction of the winding drum, and brings one of the locking base, the drive wheel, and the winding drum into contact with a restricting member that is a part of the housing or that is attached to the housing.

2. The seat belt retractor according to claim 1, wherein
the drive wheel includes engaging teeth for engagement with the moving member, and a flange portion provided on the opening direction side of the terminal end portion of the pressure container in the axial direction of the winding drum with respect to the engaging teeth, and
when the pretensioner is activated, the moving member comes into contact with the flange portion, and presses the flange portion to the opening direction side of the terminal end portion of the pressure container in the axial direction of the winding drum.

3. The seat belt retractor according to claim 1, wherein
when the pretensioner is activated, the moving member comes into contact with an end surface of the winding drum, and presses the end surface to the opening direction side of the terminal end portion of the pressure container in the axial direction of the winding drum.

4. The seat belt retractor according to claim 1, wherein
the drive wheel is provided on one end side of the winding drum via the locking base, and includes engaging teeth for engagement with the moving member,
the locking base includes a flange portion provided on the opening direction side of the terminal end portion of the pressure container in the axial direction of the winding drum with respect to the engaging teeth, and
when the pretensioner is activated, the moving member comes into contact with the flange portion, and presses the flange portion to the opening direction side of the terminal end portion of the pressure container in the axial direction of the winding drum.

5. The seat belt retractor according to claim 1, wherein
the restricting member is one of the pair of side walls of the housing.

6. The seat belt retractor according to claim 1, wherein
the pretensioner includes a cover member that houses the drive wheel and the terminal end portion of the pressure container, and that is attached to the housing, and
the restricting member is the cover member.

7. The seat belt retractor according to claim 1, further comprising a friction reduction element configured to reduce a sliding resistance due to contact between the restricting member and the one of the locking base, the drive wheel, and the winding drum.

8. The seat belt retractor according to claim 7, wherein
the friction reduction element is a bush interposed between the restricting member and the one of the locking base, the drive wheel, and the winding drum, or coating on a surface of the locking base, the drive wheel, the winding drum, or the restricting member.
